(19) United States
(12) Patent Application Publication
(10) Pub. No.: US 2026/0166596 A1
(43) Pub. Date: Jun. 18, 2026

(54) HIGH EFFICIENCY WASHING OF PLASTIC BOTTLES USING ULTRASONIC ENERGY

(71) Applicant: THE COCA-COLA COMPANY, Atlanta, GA (US)

(72) Inventors: Baris YALCIN, Roswell, GA (US); Venkat GOVINDARAJAN, Duluth, GA (US)

(21) Appl. No.: 19/126,275

(22) PCT Filed: Dec. 4, 2023
(86) PCT No.: PCT/US2023/082273

§ 371 Date: May 1, 2025

Related U.S. Application Data
(60) Provisional application No. 63/387,995, filed on Dec. 19, 2022.

(51) Int. Cl. B08B 3/12; B08B 9/20

(52) U.S. Cl. CPC B08B 3/12; B08B 9/20; B08B 2209/005

(57) ABSTRACT

The present application provides an ultrasonic bottle washing system for washing a plastic bottle. The ultrasonic bottle washing system may include an ultrasonic energy source, a container with a liquid therein, the plastic bottle positioned within the liquid of the container, and the ultrasonic energy source positioned within the plastic bottle.

### CROSS-REFERENCE TO RELATED APPLICATIONS

This application claims priority to and benefit of U.S. provisional Ser. No. 63/387,995 , filed Dec. 19, 2022, which is herein incorporated by reference.

### TECHNICAL FIELD

The present application and the resultant patent relate generally to systems and methods for washing plastic bottles and more particularly relate to systems and methods for the high efficiency washing of plastic, returnable beverage bottles using ultrasonic energy emitted via immersible sonotrodes.

### BACKGROUND OF THE INVENTION

Many different types of beverages, including carbonated soft drinks, are sold in returnable plastic bottles. Many of these plastic bottles are made from PET (polyethylene terephthalate) and the like. These bottles must be thoroughly cleaned and disinfected before being refilled to ensure product quality. Generally, the cleaning of the bottles occurs immediately before refilling. The cleaning of the bottles is typically accomplished in a bottle washing machine where the bottles travel slowly through two or more caustic immersion baths. The baths generally contain a caustic agent such as sodium hydroxide and the like as well as surfactant additives. Before entering the caustic baths, it is common to pre-spray the inside and the outside of the bottles with a low caustic solution for several seconds to remove any excess soil from the bottles. Upon exiting the caustic baths, the bottles may be rinsed in multiple water baths and then sprayed with fresh water in a final step.

The addition of ultrasonic energy has been used to assist in the cleaning of the plastic bottles. Ultrasound energy is typically applied to the caustic baths where the bottles are contained. Such a configuration requires the effective delivery of cavitation bubbles generated by an ultrasound device to assist in cleaning the walls of the bottles. The delivery and the implosion of the cavitation bubbles near a bottle wall may be less effective when several bottles are held together in a bath. Another issue is that the flexible nature of the PET material allows the bottle walls to flex with the ultrasonic waves and absorb some of the cleaning power, thereby reducing overall cleaning performance. This reduction in cleaning performance may be amplified when the cleaning is performed in a bottles-in-a-bath arrangement.

Typically, the bottles may travel for about 20-25 minutes through a conventional bottle washing machine. It would be commercially highly attractive if this cleaning time could be reduced while retaining good cleaning performance. Moreover, a reduction in the exposure time of the PET material to the caustic chemicals would extend overall bottle lifetime.

### SUMMARY OF THE INVENTION

The present application and the resultant patent thus provide an ultrasonic bottle washing system for washing a plastic bottle. The ultrasonic bottle washing system may include an ultrasonic energy source, a container with a liquid therein, the plastic bottle positioned within the liquid of the container, and the ultrasonic energy source positioned within the plastic bottle.

The present application and the resultant patent further may provide a method of washing a plastic bottle. The method may include the steps of positioning the plastic bottle in a container with liquid inside and outside of the plastic bottle, positioning a sonotrode within the plastic bottle, activating the sonotrode, and creating cavitation bobbles against a wall of the plastic bottle.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a perspective view of an ultrasonic bottle washing system as may be described herein.

FIG. 2 is a perspective view of a sonotrode that may be used with the ultrasonic bottle washing system of FIG. 1.

FIG. 3 is a side by side comparison of a bottle washed without a liquid bath and a bottle washed with a liquid bath in the ultrasonic bottle washing system of FIG. 1.

FIG. 4 is a perspective view of an alternative embodiment of an ultrasonic bottle washing system with two sonotrode rods.

FIG. 5 is a side by side comparison of bottles washed with convention methods and a bottle washed with the ultrasonic bottle washing system of FIG. 1.

FIG. 6 is a further side by side comparison of a bottle washed with convention methods and a bottle washed with the ultrasonic bottle washing system of FIG. 1.

FIG. 7 is a perspective view of a number of the sonotrodes of the ultrasonic bottle washing system used in a rotary washer.

FIG. 8 is a perspective view of a number of the sonotrodes of the ultrasonic bottle washing system used in a conveyor system.

### DETAILED DESCRIPTION

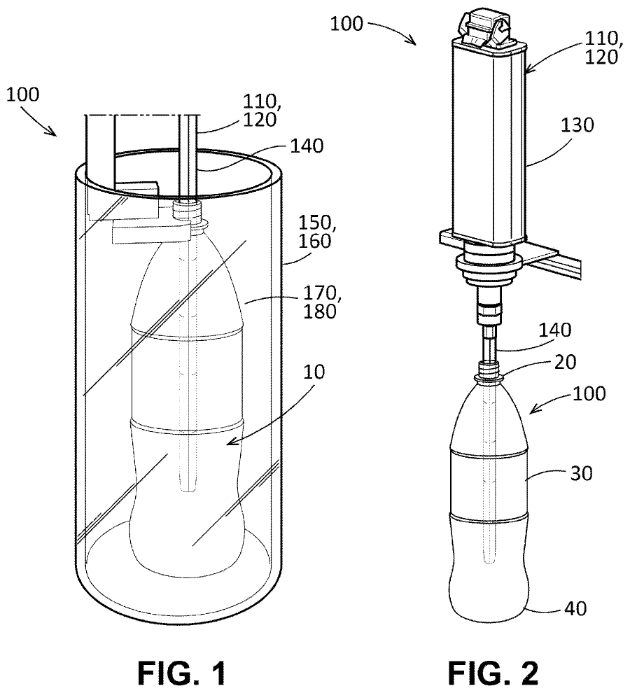

Referring now to the drawings, in which like numerals refer to like elements throughout the several views, FIGS. 1 and 2 show an example of an ultrasonic bottle washing system 100 as may be described herein. The ultrasonic bottle washing system 100 may be used to clean returnable plastic bottles 10. The plastic bottles 10 may be made out of PET and similar types of thermoplastics. The plastic bottles 10 may have a conventional neck 20, a wall 30, and a base 40. The plastic bottles 10 may have any convenient size, shape, and configuration.

The ultrasonic bottle washing system 100 may use an ultrasonic energy source 110 to clean the plastic bottles 10. In this example, the ultrasonic energy source 110 may be a sonotrode 120. Generally described, the sonotrode 120 may include a number piezoelectric transducers 130 attached to a metal rod 140. The sonotrode 120 may be operated by conventional generators, controllers, and power sources. An example sonotrode 120 is offered by Hielscher Ultrasonics GmbH of Teltow, Germany and Wanaque, New Jersey. The sonotrode 120 has the advantage of being able to transmit ultrasonic energy in a radial direction along the rod 140 as well as in an axial direction from a tip end thereof. Other types of ultrasonic energy and like may be used herein at varying frequencies.

The ultrasonic bottle washing system 100 may include a container 150 to position the bottle 10 therein. The container 150 may be in the shape of a cylindrical coaxial cavity 160 and the like. The container 150 may have any suitable size, shape, and configuration and may be made out of any suitable substantially rigid materials that may resist degradation by caustic chemical baths therein. The container 150 may hold a volume of a liquid 170 therein. The liquid 170 may be water and the like. A volume of a caustic agent 180 and different types of additives may be added therein. The caustic agent 180 may be sodium hydroxide and the like. Other components and other configurations may be used.

In use, the plastic bottle 10 may be placed in the container 150 with the liquid 170 having the caustic agent 180 both inside and outside the plastic bottle 10. The rod 140 of the sonotrode 120 may be positioned within the plastic bottle 10. The sonotrode 120 may be activated. The sonotrode 120 directs ultrasonic energy radially toward the wall 30 of the plastic bottle 10 and axially towards the base 40 of the plastic bottle 10. The ultrasonic energy creates cavitation bubbles within the plastic bottle 10. The turbulence caused by the cavitation bubbles within the liquid 170 with the caustic agent 180 serves to clean the bottle 10 as the bubbles implode against the wall 30 of the plastic bottle. The rod 140 of the sonotrode 120 may be raised and lowered within the bottle 10 to ensure complete coverage and cleaning of the plastic bottle 10. The use of radially directed ultrasonic energy allows larger bottles or bottles with complex geometries to be cleaned effectively.

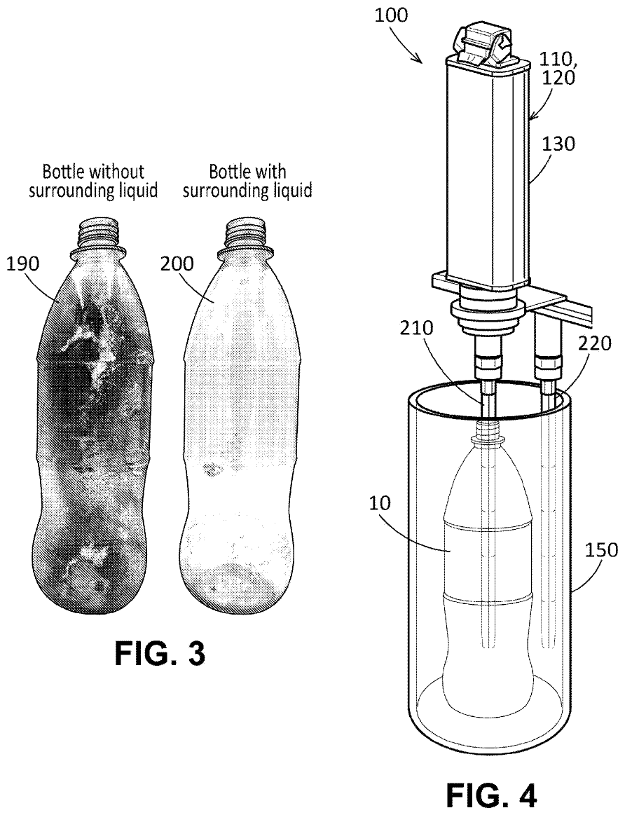

The use of the liquid 170 outside of the plastic bottle 10 has been shown to significantly improve the cleaning efficiency of the ultrasonic bottle washing system 100. Without intending to be bound by any particular theory, it is believed that the surrounding liquid 170 provides a barrier to the absorption and the flexing of the PET material caused by the ultrasonic energy. The flexing of the plastic bottle 10 apparently may limit the cleaning effectiveness in spite of the tremendous cavitation occurring inside the plastic bottle 10. The improvement in cleaning with the use of the liquid 170 outside of the plastic bottle 10 is shown in FIG. 3. Both bottles 190 and 200 were stained with an aqueous methylene blue solution. The bottle 190 was cleaned without liquid surrounding the bottle while the bottle 200 was cleaned with liquid surrounding the bottle. As can be seen, the bottle 190 is still coated with the blue staining while the bottle 200 is significantly cleaner.

FIG. 4 shows a further embodiment of the ultrasonic bottle washing system 100 as may be described herein. In this example, either two sonotrode 120 or a single sonotrode 120 with two rods 140 may be used. Specifically, a first rod 210 may be positioned inside the plastic bottle 10 and a second rod 220 may be positioned outside of the plastic bottle 10. The first rod 210 may be used to clean the inside of the plastic bottle 10 as described above and the second rod 220 may be used to clean the outside of the plastic bottle 10. The container 150 may rotate so as to ensure complete coverage and cleaning of the outside of the plastic bottle 10 by the second rod 220. Other components and other configurations may be used herein.

To test the effectiveness of cleaning performance of the ultrasonic bottle washing system 100 and to compare this performance to traditional washing methods, a number of the plastic bottles 10 were soiled using a blend of starch, protein, and natural fertilizer dissolved in an alkaline water solution. The solution was applied to the inside of the plastic bottles 10 and dried for about 14 hours at about 60° C. When necessary, soil was applied twice to increase its amount. It is important to note that the degree of soiling created in these plastic bottles 10 is substantially higher than what is typically encountered in bottle cleaning plants. Such soiled bottles 10 would normally be rejected immediately without even attempting to clean them. An assessment of the degree of cleaning was done visually by staining the already cleaned plastic bottles 10 with the aqueous methylene blue solution.

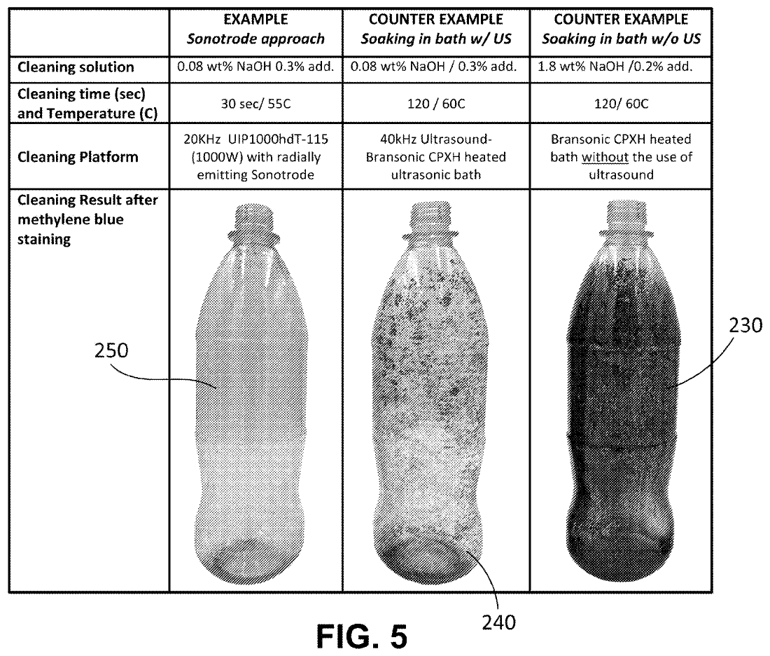

As is shown in FIG. 5, three plastic bottles 10 were cleaned in three different ways. A bottle 230 was cleaned in a two minute, hot caustic bath (1.8 wt % NaOH at 60° C.). One can see from the methylene blue staining that the washed bottle 230 is substantially soiled with almost no soil removal. This shows the stubbornness of the soil prepared for this trial. A bottle 240 was cleaned with ultrasound under the same temperature and duration of the bottle 230 but with a substantially reduced caustic concentration (0.8 wt % NaOH). One can see from the methylene blue staining that the bottle 240 is cleaner although significant stains are still visible.

When the two counterexamples described above are compared to an example bottle 250 washed in the ultrasonic bottle washing system 100 described herein, the superiority in cleaning effectiveness is quite apparent. The bottle 250 is substantially free of blue stains even though it was washed at a lower temperature and for a shorter duration (55° C. for 30 seconds) and at a lower caustic concentration (0.8 wt % NaOH). Mild blue stains remaining only near the neck 20 due to the experimental setup. When fully immersed, these stains should completely disappear.

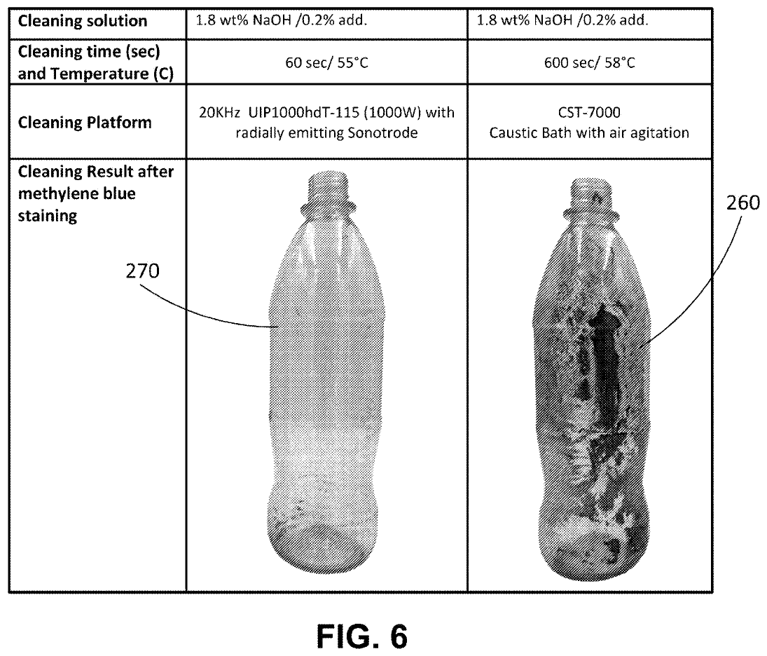

As is shown in FIG. 6, a further trial was made using a conventional pilot bottle washing machine. In both cleaning examples, 1.8 wt % NaOH was used with a 0.2% additive. In the conventional cleaning of a bottle 260, a ten minute caustic soak was used followed by a quick water rinse. In the use of the ultrasonic bottle washing system 100, a bottle 270 was cleaned for one minute in the caustic liquid followed by the same quick water rinse. As is shown, the conventional bottle washing machine could not clean these soiled bottles even after 10 minutes while the radial emitting sonotrode approach of the ultrasonic bottle washing system 100 described herein is a significant improvement in cleaning the plastic bottles 10.

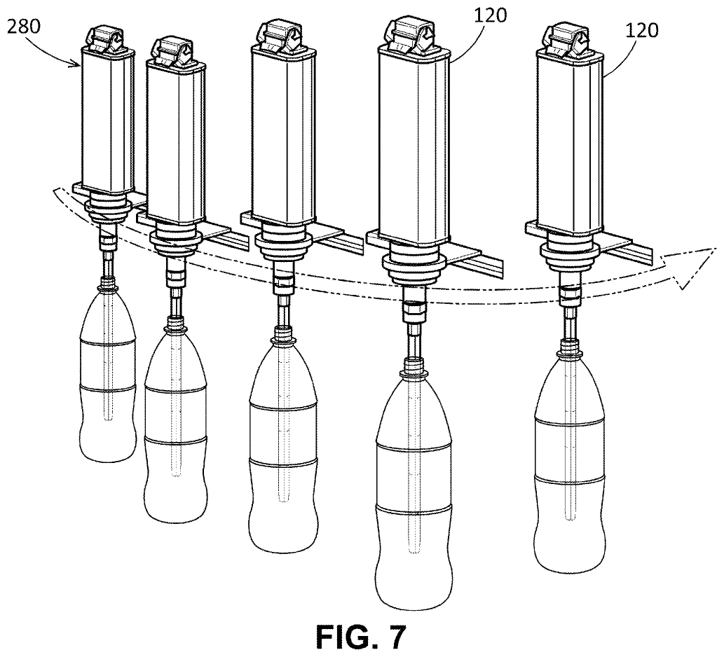

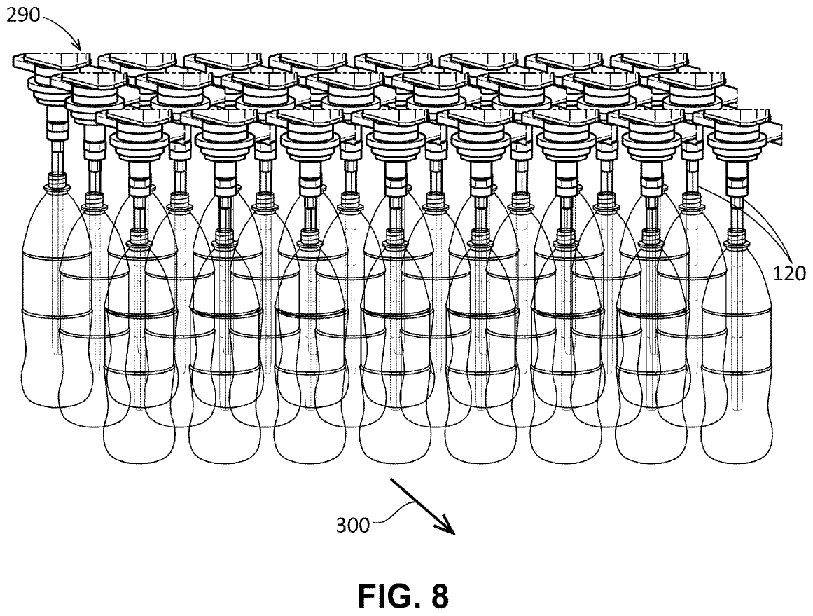

In order to utilize the ultrasonic bottle washing system 100 described herein in a high-speed bottling washing plant, one can envision different methods of adaption. In one scenario, the ultrasonic bottle washing system 100 could be incorporated into a high speed rotary sprayer or other types or high speed rotational devices. As is shown in FIG. 7, a rotary washer 280 could use the sonotrodes 120 instead of spraying elements. Likewise, the ultrasonic bottle washing system 100 may be used as a pretreatment step before the plastic bottles 10 reach a washer. FIG. 8 shows a conveyor system 290 where the sonotodes 120 may be positioned about a conveyor 300. The sonotrodes 120 may be inserted into the plastic bottles 10, for example, during a de-crating step (at least for the inside of the plastic bottles 10) which can take up to 30 seconds when the plastic bottles 10 are moving along the conveyors 300. Many other types of high speed applications may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. An ultrasonic bottle washing system for washing a plastic bottle, comprising:
an ultrasonic energy source;
a container with a liquid therein;
the plastic bottle positioned within the liquid of the container; and
the ultrasonic energy source positioned within the plastic bottle.

2. The ultrasonic bottle washing system of claim 1, wherein the ultrasonic energy source comprises a sonotrode.

3. The ultrasonic bottle washing system of claim 2, wherein the sonotrode comprises one or more transducers and a rod.

4. The ultrasonic bottle washing system of claim 3, wherein the rod is positioned within the plastic bottle.

5. The ultrasonic bottle washing system of claim 2, wherein the sonotrode comprises a first rod and a second rod.

6. The ultrasonic bottle washing system of claim 5, wherein the first rod is positioned within the plastic bottle and the second rod is positioned outside of the plastic bottle.

7. The ultrasonic bottle washing system of claim 2, wherein the sonotrode emits ultrasonic energy in a radial direction.

8. The ultrasonic bottle washing system of claim 1, wherein the container comprises a cylindrical cavity.

9. The ultrasonic bottle washing system of claim 1, wherein the liquid comprises water with a caustic agent therein.

10. The ultrasonic bottle washing system of claim 9, wherein the caustic agent comprises sodium hydroxide.

11. The ultrasonic bottle washing system of claim 1, wherein the ultrasonic energy source may be raised and lowered within the plastic bottle.

12. The ultrasonic bottle washing system of claim 1, wherein the container may rotate.

13. The ultrasonic bottle washing system of claim 2, further comprising a plurality of sonotrodes positioned in a rotary washer.

14. The ultrasonic bottle washing system of claim 2, further comprising a plurality of sonotrodes positioned in a conveyor system.

15. A method of washing a plastic bottle, comprising:
positioning the plastic bottle in a container with liquid inside and outside of the plastic bottle;
positioning a sonotrode within the plastic bottle;
activating the sonotrode; and
creating captivation bobbles against a wall of the plastic bottle.
